(19) United States
(12) Patent Application Publication
(10) Pub. No.: US 2015/0233468 A1
(43) Pub. Date: Aug. 20, 2015

(54) Personalized gear shift lever

(71) Applicant: Rodolfo Rivera, JR., El Paso, TX (US)

(72) Inventor: Rodolfo Rivera, JR., El Paso, TX (US)

(21) Appl. No.: 14/633,119

(22) Filed: Feb. 26, 2015

Related U.S. Application Data
(60) Provisional application No. 61/942,206, filed on Feb. 20, 2014.

(51) Int. Cl. F16H 59/02; G09F 7/16

(52) U.S. Cl. CPC F16H 59/0278; G09F 7/165

(57) ABSTRACT

A personalized gear shift lever provides letter cutouts spelling the user's name or initials, or photo frames containing the user's photographs, along the length of the shaft. The base is formed from tubular steel with a square cross-section, and is secured to the floor of the cab by one or more bolts. The sides of the shaft display letter cutouts or photo frames, illuminated by white or colored lights which may be battery-powered, or powered by the vehicle's electric system. An enlarged, decorative gear shift knob dominates the upper end of the lever.

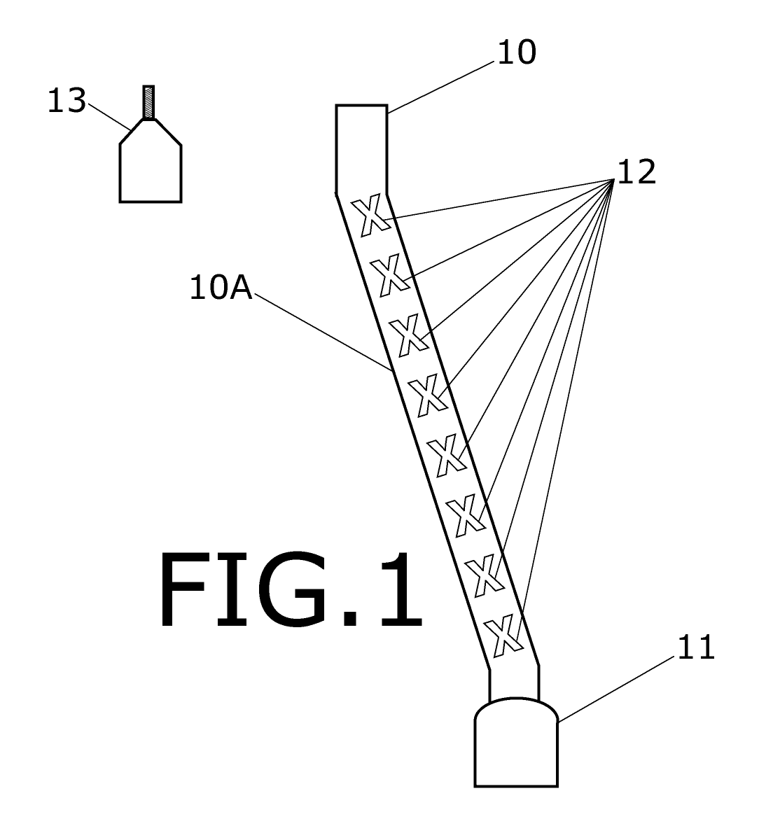

### CROSS-REFERENCE TO RELATED APPLICATIONS

This application claims the benefit of U.S. Provisional Application No. 61/942,206, filed Feb. 20, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vehicle accessories, and in particular to a personalized gear shift lever. For most long-distance truck drivers, the cab of the truck is both home and office. Drivers often spend 24 hours a day in the cabs of their vehicles, emerging only to refuel, shower, and use the facilities at truck stops. Many are owner-operators and may customize the vehicle interior as they please. The owners of recreational vehicles also spend a large amount of time in their vehicles, and usually choose to personalize their vehicles to make them more like home. Such drivers are looking for custom parts and equipment that will be functional, but still express their own individuality and add a touch of style to the vehicle interior. A personalized gear shift lever, which displays the owner's name or photographs in the form of cutout letters or photo frames along the length of the shaft, would satisfy this demand.

### SUMMARY OF THE INVENTION

Accordingly, the invention is directed to a personalized gear shift lever. The lever provides letter cutouts spelling the user's name or initials, or photo frames containing the user's photographs, along the length of the shaft. The base is formed from tubular steel with a square cross-section, and is secured to the floor of the cab by one or more bolts. The sides of the shaft display letter cutouts or photo frames, illuminated by white or colored lights which may be battery-powered, or powered by the vehicle's electric system. An enlarged, decorative gear shift knob dominates the upper end of the lever.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

The FIGURE is a side view of the first exemplary embodiment with the gear shift knob removed, displaying the lever 10, the shaft 10A, the base 11, the letter cutouts 12, and the gear shift knob 13.

### DETAILED DESCRIPTION OF THE INVENTION

Referring now to the invention in more detail, the invention is directed to a personalized gear shift lever 10. The lever 10 provides letter cutouts 12 spelling the user's name or initials, or photo frames containing the user's photographs, along the length of the shaft 10A. The base 11 is formed from tubular steel with a square cross-section, and is secured to the floor of the cab by one or more bolts. The base 11 permits the shiftable motion of the lever 10 such that the lever 10 is interlinked with the transmission system of the vehicle, whether manual or automatic. The sides of the shaft 10A display letter cutouts or photo frames, illuminated by white or colored lights which may be battery-powered, or powered by the vehicle's electric system. An enlarged, decorative gear shift knob 13 dominates the upper end of the lever 10, opposite the base 11.

The first and second exemplary embodiments are intended for installation as an after-market modification by the user, or by a vehicle repair or customizing shop. Alternate embodiments, which may be installed as original equipment options by the vehicle manufacturers, are also contemplated. The first exemplary embodiment provides letter cutouts 12 (the cutouts may be uppercase or lowercase alphabetic characters as well as numerals, symbols, or glyphs for use in writing languages other than English) along the entire length of both sides of the shaft 10A, spelling the user's name or initials, or providing another word or phrase of the user's choice. The shape and colors of the gear shift knob 13, and the color or colors of the paint on the shaft 10A, may be selected to complement the user's word choice, such as green and gold paint on a shaft 10A displaying the word “Packers” in letter cutouts 12, and a gear shift knob 13 in the image of a wedge of cheese or a football helmet, to demonstrate the user's support for the Green Bay Packers of the National Football League.

The second exemplary embodiment is intended to display photo inserts in a series of small photo frames along the entire length of the shaft 10A. Transparent covers securing the user's photographs are easily removed with a coin or simple hand tool, and snapped back into position with gentle hand pressure. Both the first and second exemplary embodiments may also provide additional decorative features, such as pinstriping and laser-engraved scrollwork. The photo inserts of the second exemplary embodiment are analogous to the cutouts 12 along the shaft 10A. Generically, the cutouts 12, photo inserts, engravings, paintings, or other cuts, marks, or insertions may be understood as “indicia”. Any indicia, whether including a photo insert or not, may be filled with a transparent or translucent cover material.

To use the first exemplary embodiment, the user simply operates the gear shift lever 10 in the same manner as any standard floor-mounted gear shift lever.

The shaft 10A and base 11 are preferably manufactured from durable, rigid materials, such as steel, aluminum alloy, or brass, and may feature chromium alloy plating. Preferably, the shaft 10A and base 11 are manufactured from tubular metal with a square cross section, one inch to one and one-half inches wide. The gear shift knob 13 is preferably manufactured from durable, rigid materials with a decorative property, such as steel, aluminum alloy, brass, wood, or acrylic polymer. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A personalized gear shift lever comprising a shift lever; said shift lever comprising a shaft; a knob; a base; said knob being affixed to said shaft opposite said base; said base being shiftably affixed to said shaft; said shaft bearing one or more indicia.

2. The personalized gear shift lever of claim 1 wherein said one or more indicia comprise cutout letters, numbers, or symbols.

3. The personalized gear shift lever of claim 1 wherein said one or more indicia comprise photo inserts.

4. The personalized gear shift lever of claim 1 wherein said shaft is internally illuminated.

5. The personalized gear shift lever of claim 2 wherein said shaft is internally illuminated.

6. The personalized gear shift lever of claim 3 wherein said shaft is internally illuminated.

7. The personalized gear shift lever of claim 1 wherein said knob is enlarged and bears decorative elements.

8. The personalized gear shift lever of claim 2 wherein said knob is enlarged and bears decorative elements.

9. The personalized gear shift lever of claim 3 wherein said knob is enlarged and bears decorative elements.

10. The personalized gear shift lever of claim 4 wherein said knob is enlarged and bears decorative elements.

11. The personalized gear shift lever of claim 5 wherein said knob is enlarged and bears decorative elements.

12. The personalized gear shift lever of claim 6 wherein said knob is enlarged and bears decorative elements.
